(19) United States
(12) Patent Application Publication
(10) Pub. No.: US 2023/0222909 A1
(43) Pub. Date: Jul. 13, 2023

(54) CONTROL METHOD, MOVING BODY, AND RECORDING MEDIUM

(71) Applicant: Panasonic Intellectual Property Corporation of America, Torrance, CA (US)

(72) Inventors: Junji MICHIYAMA, Fukuoka (JP); Yuji UNAGAMI, Osaka (JP); Naohisa NISHIDA, Osaka (JP); Kakuya YAMAMOTO, Hyogo (JP); Yuuki HIROSE, Osaka (JP); Motoji OHMORI, Osaka (JP); Tetsuji FUCHIKAMI, Osaka (JP)

(21) Appl. No.: 18/124,234

(22) Filed: Mar. 21, 2023

Related U.S. Application Data
(63) Continuation of application No. PCT/JP2021/036874, filed on Oct. 5, 2021.
(60) Provisional application No. 63/089,261, filed on Oct. 8, 2020.
(60) Provisional application No. 63/089,257, filed on Oct. 8, 2020.
(60) Provisional application No. 63/089,250, filed on Oct. 8, 2020.

(51) Int. Cl. G08G 1/0967

(52) U.S. Cl. CPC G08G 1/096791; G08G 1/096783; G08G 1/095

(57) ABSTRACT

A control method for a first moving body includes: acquiring, from a second moving body, emergency information that includes information on a scheduled route on which an emergency vehicle travels in an emergency; and transmitting, by device-to-device communication, the emergency information to a third moving body that is predicted to travel on the scheduled route.

### CROSS REFERENCE TO RELATED APPLICATIONS

This is a continuation application of PCT International Application No. PCT/JP2021/036874 filed on Oct. 5, 2021, designating the United States of America, which is based on and claims priority of U.S. Provisional Patent Application No. 63/089,250 filed on Oct. 8, 2020, U.S. Provisional Patent Application No. 63/089,257 filed on Oct. 8, 2020, and U.S. Provisional Patent Application No. 63/089,261 filed on Oct. 8, 2020. The entire disclosures of the above-identified applications, including the specifications, drawings and claims are incorporated herein by reference in their entirety.

### FIELD

The present disclosure relates to a control method, a moving body, and a recording medium.

### BACKGROUND

Patent Literature (PTL) 1 discloses a method for transmitting and receiving data between vehicles traveling on a road, that is, in the so-called vehicle-to-vehicle communication.

### CITATION LIST

### Patent Literature

PTL 1: Japanese Unexamined Patent Application Publication No. 2001-283381

### SUMMARY

### Technical Problem

Incidentally, an emergency vehicle uses a siren sound or a warning light to notify surrounding vehicles that the emergency vehicle is traveling in an emergency, and thereby urges the surrounding vehicles to take an avoidance action such that the emergency vehicle can travel preferentially. However, although the surrounding vehicles can determine, by the siren sound or the warning light, that the emergency vehicle is approaching, the surrounding vehicles cannot find a scheduled route on which the emergency vehicle travels.

The present disclosure is made in view of the foregoing circumstances, and an object of the present disclosure is to provide a control method, a moving body, and a recording medium that utilize vehicle-to-vehicle (device-to-device) communication to be able to effectively notify surrounding vehicles of a scheduled route on which an emergency vehicle travels.

### Solution to Problem

A control method according to an aspect of the present disclosure is a control method for a first moving body, and includes: acquiring, from a second moving body, emergency information that includes route information on a scheduled route on which an emergency vehicle travels in an emergency; and transmitting, by device-to-device communication, the emergency information to a third moving body that is predicted to travel on the scheduled route.

These comprehensive or specific aspects may be realized by a system, a device, an integrated circuit, a computer program, or a computer-readable recording medium such as a CD-ROM or may be realized by any combination of a system, a device, an integrated circuit, a computer program, and a recording medium.

### Advantageous Effects

In a control method and the like according to the present disclosure, device-to-device communication is utilized, and thus it is possible to effectively notify surrounding vehicles of a scheduled route on which an emergency vehicle travels.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram showing an example of the configuration of a notification system in Embodiment 1.

FIG. 2 is a diagram showing an example of the configuration of a vehicle in Embodiment 1.

FIG. 3 is a diagram showing an example of the configuration of an emergency vehicle in Embodiment 1.

FIG. 4 is a diagram showing an example of the configuration of a traffic light in Embodiment 1.

FIG. 5 is a sequence diagram showing an example of notification processing performed by the notification system in Embodiment 1.

FIG. 6 is a flowchart showing an example of transmission processing performed by the vehicle in Embodiment 1.

FIG. 7 is a sequence diagram showing another example of the notification processing performed by the notification system in Embodiment 1.

FIG. 8 is a flowchart showing an example of transmission processing performed by the traffic light in Embodiment 1.

FIG. 9 is a flowchart showing an example of avoidance processing performed by the vehicle in Embodiment 1.

FIG. 10 is a flowchart showing another example of the avoidance processing performed by the vehicle in Embodiment 1.

FIG. 11 is a diagram showing an example of the configuration of a notification system in Embodiment 2.

FIG. 12 is a sequence diagram showing an example of notification processing performed by the notification system in Embodiment 2.

FIG. 13 is a flowchart showing an example of signal processing performed by a traffic light in Embodiment 2.

FIG. 14 is a diagram showing an example of the configuration of a notification system in Embodiment 3.

FIG. 15 is a diagram showing an example of the configuration of a server in Embodiment 3.

FIG. 16 is a sequence diagram showing an example of notification processing performed by the notification system in Embodiment 3.

FIG. 17 is a flowchart showing an example of transmission processing performed by a vehicle in Embodiment 3.

FIG. 18 is a flowchart showing an example of avoidance processing performed by the vehicle in Embodiment 3.

FIG. 19 is a diagram showing an example of the configuration of a vehicle in Embodiment 4.

FIG. 20 is a flowchart showing an example of an operation performed by the vehicle in Embodiment 4.

FIG. 21 is a flowchart showing another example of the operation performed by the vehicle in Embodiment 4.

FIG. 22 is a sequence diagram showing an example of an operation performed by a notification system in Embodiment 4.

FIG. 23 is a flowchart showing another example of the operation performed by the vehicle in Embodiment 4.

### DESCRIPTION OF EMBODIMENTS

### Underlying Knowledge Forming Basis of the Present Disclosure

An emergency vehicle which travels in an emergency uses a siren sound or a warning light to notify surrounding vehicles that the emergency vehicle is traveling in an emergency, and thereby urges the surrounding vehicles to take an avoidance action such that the emergency vehicle can travel preferentially. However, although the surrounding vehicles can determine, by the siren sound or the warning light, that the emergency vehicle is approaching, the surrounding vehicles cannot find a scheduled route on which the emergency vehicle travels. Hence, it is likely that even a vehicle which does not need to take the avoidance action takes the avoidance action, and this may lead to the occurrence of a traffic jam. Therefore, each vehicle may consume extra energy.

Hence, the present inventors have found a control method, a moving body, and a recording medium that can provide a notification to only vehicles which are highly likely to obstruct the emergency travel of an emergency vehicle in order to effectively notify surrounding vehicles that the emergency vehicle is traveling in an emergency.

A control method according to an aspect of the present disclosure is a control method for a first moving body, and includes: acquiring, from a second moving body, emergency information that includes route information on a scheduled route on which an emergency vehicle travels in an emergency; and transmitting, by device-to-device communication, the emergency information to a third moving body that is predicted to travel on the scheduled route.

In this way, the emergency information including the information on the scheduled route on which the emergency vehicle travels in an emergency is transmitted by the device-to-device communication to the third moving body that is predicted to travel on the scheduled route. Hence, it is possible to notify the emergency information to only the third moving body which is highly likely to obstruct the emergency travel of the emergency vehicle. Therefore, the device-to-device communication is utilized, and thus it is possible to effectively notify surrounding vehicles of the scheduled route on which the emergency vehicle travels.

The emergency information may further include lane information indicating a lane in which the emergency vehicle is traveling in an emergency, and the third moving body may be traveling in the lane.

Hence, it is possible to determine that the moving body traveling in the same line as the line in which the emergency vehicle is traveling in an emergency is highly likely to obstruct the emergency travel.

The emergency information may include a travel speed and a current location of the emergency vehicle, and the control method may further include: estimating, based on the emergency information, an estimated time at which the first moving body will be overtaken by the emergency vehicle, and stopping, before the estimated time, the first moving body on a shoulder of a road on which the first moving body is traveling.

Hence, before the first moving body is overtaken by the emergency vehicle, the first moving body can be moved to the shoulder which does not obstruct the travel of the emergency vehicle.

The emergency information may include travel speed information and current location information of the emergency vehicle, and the control method may further include: estimating, based on the travel speed information and the current location information, an estimated time at which the first moving body will be overtaken by the emergency vehicle, and moving the first moving body to a route different from the scheduled route before the estimated time.

Hence, before the first moving body is overtaken by the emergency vehicle, the first moving body can be moved to the route which does not obstruct the travel of the emergency vehicle.

The transmitting may include transmitting, when the third moving body is non-existent, the emergency information to a roadside device near the first moving body.

Hence, the emergency information is notified to the roadside device, and thus, for example, it is possible to cause the roadside device to notify the emergency information to another vehicle which thereafter passes through an area near the roadside device.

The control method may further include: inquiring, when the emergency information is acquired, whether authority information indicating that the emergency vehicle is an authorized emergency vehicle is stored in a blockchain, and the transmitting may include transmitting, when the authority information is stored in the blockchain, the emergency information to the third moving body or a roadside device near the first moving body.

Hence, it is possible to suppress the performance of control for prioritizing the travel of a vehicle which transmits, based on unauthorized emergency information, the unauthorized emergency information.

The control method may further include: moving the first moving body within a communication range of the roadside device when the first moving body cannot communicate with the third moving body or the roadside device in the transmitting.

Hence, the received emergency information can be notified to the roadside device.

The control method may further include: providing a user a presentation prompting the user to move the first moving body within a communication range of the roadside device when the first moving body cannot communicate with the third moving body or the roadside device in the transmitting.

Hence, it is possible to prompt the user to perform the operation for notifying the received emergency information to the roadside device.

The roadside device may include a traffic light.

A moving body according to an aspect of the present disclosure is a moving body, and includes: an acquirer that acquires, from a first moving body, emergency information that includes information on a scheduled route on which an emergency vehicle travels in an emergency; and a transmitter that transmits, by device-to-device communication, the emergency information to a second moving body that is predicted to travel on the scheduled route.

In this way, the emergency information including the information on the scheduled route on which the emergency vehicle travels in an emergency is transmitted by the device-to-device communication to the third moving body that is predicted to travel on the scheduled route. Hence, it is possible to notify the emergency information to only the third moving body which is highly likely to obstruct the emergency travel of the emergency vehicle. Therefore, the device-to-device communication is utilized, and thus it is possible to effectively notify surrounding vehicles of the scheduled route on which the emergency vehicle travels.

A recording medium according to an aspect of the present disclosure is a non-transitory computer-readable recording medium having recorded thereon a program for causing a computer to execute the control method described above.

In this way, the emergency information including the information on the scheduled route on which the emergency vehicle travels in an emergency is transmitted by the device-to-device communication to the third moving body that is predicted to travel on the scheduled route. Hence, it is possible to notify the emergency information to only the third moving body which is highly likely to obstruct the emergency travel of the emergency vehicle. Therefore, the device-to-device communication is utilized, and thus it is possible to effectively notify surrounding vehicles of the scheduled route on which the emergency vehicle travels.

Embodiments will be described below with reference to drawings. Each of the embodiments described below shows a specific example of the present disclosure. Specifically, the numerical values, shapes, materials, constituent elements, the arrangement and connection of the constituent elements, steps, the order of the steps, and the like shown in the following embodiments are examples, and are not intended to limit the present disclosure. Although among the constituent elements in the following embodiments, constituent elements which are not recited in any one of the independent claims indicating the top-level concept are not necessarily needed in order to solve the problem of the present disclosure, they are described as optional constituent elements.

### Embodiment 1

A system configuration in the present disclosure will first be described.

A notification system in the present disclosure includes a plurality of vehicles which can perform device-to-device communication with each other. The vehicles include an emergency vehicle. Each of the vehicles other than the emergency vehicle sequentially transmits, by the device-to-device communication, emergency information received from the emergency vehicle to another vehicle, and thereby notifies the emergency information to the other vehicles.

The device-to-device communication is also called vehicle-to-vehicle communication (or hop communication), and is, for example, one-to-one communication by which two vehicles exchange information with each other. The device-to-device communication is wireless communication. Each of the vehicles receives information from another vehicle, and transmits the information to yet another vehicle. In other words, each of the vehicles serves as a relay to transmit and receive information in a relay manner.

### [Notification System]

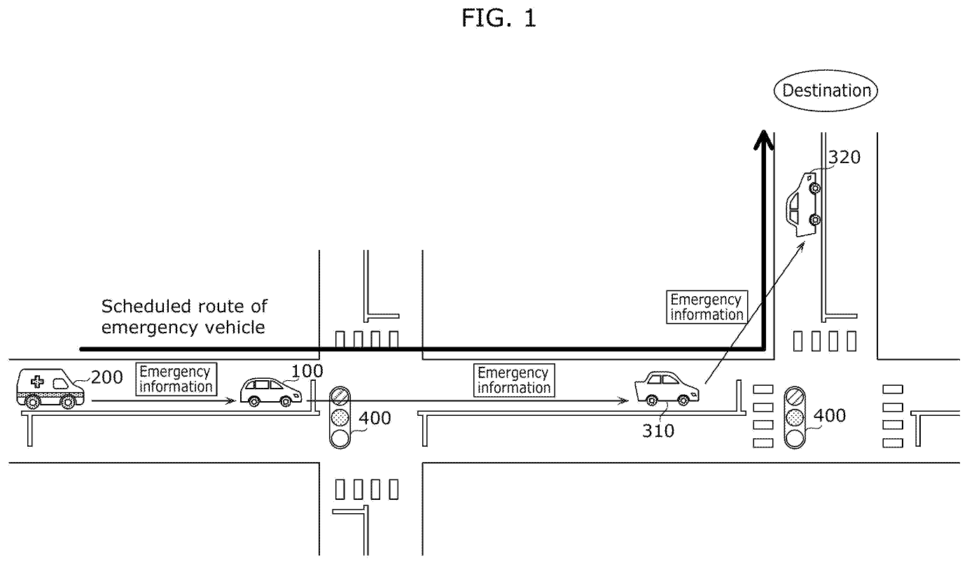

FIG. 1 is a diagram showing an example of the configuration of a notification system in Embodiment 1.

As shown in FIG. 1, for example, the notification system in the present embodiment includes vehicles 100, 310, and 320 and emergency vehicle 200. The notification system may further include traffic lights 400. Vehicles 100, 310, and 320, emergency vehicle 200, and traffic lights 400 can perform the device-to-device communication with each other. Specifically, when vehicles 100, 310, and 320, emergency vehicle 200, and traffic lights 400 are within a communication range of each other, they can perform wireless communication with each other.

Vehicles 100, 300, 310, and 320 and emergency vehicle 200 are examples of a moving body. Traffic light 400 is an example of a roadside device.

The device-to-device communication is, for example, communication which utilizes a dedicated frequency of 760 MHz in intelligent transport systems (ITS) in Japan. A communication distance in the device-to-device communication is about several hundred meters.

When emergency vehicle 200 travels in an emergency, emergency vehicle 200 transmits, for example, to vehicle 100 in the direction of travel, the emergency information indicating that emergency vehicle 200 is travelling in an emergency. The emergency information includes route information on a scheduled route on which emergency vehicle 200 travels in an emergency. The emergency travel refers to travel of emergency vehicle 200 for performing an emergency operation such as lifesaving, firefighting, or a security operation, and indicates that emergency vehicle 200 travels on a road in preference to other vehicles. Examples of emergency vehicle 200 include an ambulance, a fire engine, a patrol car, and the like. The route information may be information indicating the scheduled route itself on which emergency vehicle 200 travels in an emergency or may be information indicating a destination to which emergency vehicle 200 travels in an emergency. In the following description, the scheduled route on which emergency vehicle 200 travels in an emergency is referred to as the scheduled route.

The emergency information may include lane information indicating a lane in which emergency vehicle 200 is traveling in an emergency. The emergency information may also include the travel speed and the current location of emergency vehicle 200. The travel speed is the travel speed of emergency vehicle 200 when the emergency information is generated. The current location is the position of emergency vehicle 200 when the emergency information is generated.

When vehicle 100 receives the emergency information from emergency vehicle 200, vehicle 100 transmits, by the device-to-device communication, the received emergency information to vehicle 310 which is predicted to travel on the scheduled route identified from the route information included in the emergency information. Furthermore, when vehicle 310 receives the emergency information from emergency vehicle 200, vehicle 310 transmits, by the device-to-device communication, the received emergency information to vehicle 320 which is predicted to travel on the scheduled route identified from the route information included in the emergency information.

In this way, the emergency information transmitted from emergency vehicle 200 is transmitted to vehicles 100, 310, and 320 which are traveling on the scheduled route of emergency vehicle 200. Hence, it can be determined that vehicles 100, 310, and 320 receiving the emergency information are traveling on the scheduled route on which emergency vehicle 200 travels in an emergency, and thus vehicles 100, 310, and 320 can perform, until they are overtaken by emergency vehicle 200, an avoidance action for pulling over on the travel route so that emergency vehicle 200 can travel preferentially.

Although an example where the emergency information is generated by the emergency vehicle is shown, the present embodiment is not limited to this example. For example, when a vehicle which travels near the emergency vehicle detects the siren sound or the warning light of the emergency vehicle, the vehicle may generate the emergency information and transmit it to a third moving body. Instead of the vehicle, a traffic light or a roadside device installed on the side of a road on which the emergency vehicle is travelling may generate the emergency information and transmit it to the third moving body. In this case, the emergency information may include information on the direction of travel of the emergency vehicle and a lane in which the emergency vehicle is traveling.

### [Vehicle]

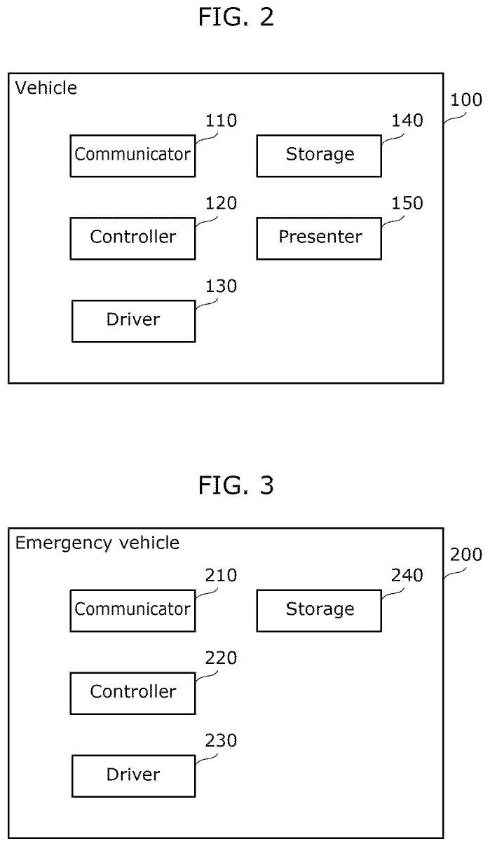

FIG. 2 is a diagram showing an example of the configuration of the vehicle in Embodiment 1.

As shown in FIG. 2, vehicle 100 includes communicator 110, controller 120, driver 130, and storage 140. Vehicle 100 may further include presenter 150. A processor uses a memory to execute predetermined programs, and thus the functions of vehicle 100 can be realized. The constituent elements will be described below.

Communicator 110 performs the device-to-device communication with emergency vehicle 200 or vehicle 310 or 320 to transmit and receive information. Communicator 110 acquires the emergency information from another vehicle. Here, communicator 110 may directly acquire the emergency information from emergency vehicle 200 or may acquire the emergency information via another vehicle. The above-described vehicle which transmits the emergency information is an example of a second moving body. Then, communicator 110 transmits, by the device-to-device communication, the emergency information to a vehicle which is predicted to travel on the scheduled route. The vehicle which is predicted to travel on the scheduled route may be identified by controller 120. Communicator 110 may be realized by communication IF for performing the device-to-device communication.

There are two types of device-to-device communication, that is, a request-response type and a broadcast type. In the request-response type, a vehicle which receives information transmits a communication request signal including the vehicle ID of the vehicle by broadcasting the communication request signal. On the other hand, when a vehicle which transmits the information receives the communication request signal, the vehicle transmits the information to the vehicle of the vehicle ID included in the communication request signal. By contrast, in the broadcast type, a communication partner is not identified. A vehicle which transmits information transmits the information by broadcasting the information. Then, all vehicles which are included in a communication range receive the information which has been broadcast. Here, when the emergency information is transmitted by the device-to-device communication, the broadcast type of the two types described above is appropriate. However, the present embodiment is not limited to the broadcast type, and the request-response type may be adopted.

Controller 120 identifies the scheduled route of emergency vehicle 200 based on the emergency information acquired by communicator 110. When the route information included in the emergency information indicates the scheduled route, controller 120 may identify the scheduled route by acquiring the route information. When the route information included in the emergency information indicates the destination of emergency vehicle 200, controller 120 may identify the scheduled route by estimating a route up to the destination. The route up to the destination which is estimated may include a plurality of patterns of routes. Controller 120 searches for another vehicle which is traveling on the scheduled route identified and is in a state capable of performing communication. In the search described above, controller 120 may search for traffic light 400 capable of performing communication.

When controller 120 finds vehicle 310 as another vehicle, controller 120 may transmit the emergency information to vehicle 310 via communicator 110. When controller 120 cannot find another vehicle (that is, when another vehicle is non-existent), controller 120 may transmit the emergency information to traffic light 400 via communicator 110. The above-described vehicle to which the emergency information is transmitted is an example of the third moving body. When controller 120 cannot communicate with another vehicle or traffic light 400, controller 120 may control driver 130 to move vehicle 100 within the communication range of traffic light 400. Here, controller 120 may move vehicle 100 within the communication range of traffic light 400 which is located closest to vehicle 100. Controller 120 may also move vehicle 100 within the communication range of traffic light 400 which is located closest to vehicle 100 on the travel route of vehicle 100. Controller 120 may move vehicle 100 so as to enter a state capable of communicating with another vehicle or traffic light 400. In this case, controller 120 may move vehicle 100 on the scheduled route on which vehicle 100 travels. When controller 120 cannot communicate with another vehicle or traffic light 400, controller 120 may provide, to presenter 150, a presentation prompting a user to move vehicle 100 within the communication range of traffic light 400.

When the emergency information includes the travel speed and the current location of emergency vehicle 200, controller 120 may estimate, based on the travel speed and the current location, an estimated time at which vehicle 100 will be overtaken by emergency vehicle 200. Then, controller 120 may control driver 130 to stop, before the estimated time, vehicle 100 on the shoulder of the road on which vehicle 100 is traveling. Controller 120 may also control driver 130 to move, before the estimated time, vehicle 100 to a route different from the scheduled route.

When communication with another vehicle is established, controller 120 may acquire the position information of the vehicle described above from the vehicle, and compare it with the position information of vehicle 100 to identify in which direction the vehicle is located relative to vehicle 100. When communication with another vehicle is established, controller 120 may acquire, from the vehicle described above, a scheduled route on which the vehicle travels.

Driver 130 is an operator which performs operations on the movement of vehicle 100 such as the travel, the steering, the braking, and the like of vehicle 100. Driver 130 may be realized, for example, by an engine, a motor, steering, a brake, and the like.

Storage 140 stores the emergency information received by communicator 110. Storage 140 may delete the stored emergency information after vehicle 100 is overtaken by emergency vehicle 200. Storage 140 may be realized, for example, by a hard disk drive (HDD), a solid state drive (SSD), and the like.

Presenter 150 provides, to the user, the presentation prompting the user to move vehicle 100 within the communication range of traffic light 400. Presenter 150 may display an image or characters indicating the presentation on a display included in vehicle 100 to provide the presentation to the user or may output a voice indicating the presentation from a speaker included in vehicle 100 to provide the presentation to the user. Presenter 150 may be realized, for example, by a display, a speaker, and the like.

### [Emergency Vehicle]

FIG. 3 is a diagram showing an example of the configuration of the emergency vehicle in Embodiment 1.

As shown in FIG. 3, emergency vehicle 200 includes communicator 210, controller 220, driver 230, and storage 240. A processor uses a memory to execute predetermined programs, and thus the functions of emergency vehicle 200 can be realized. The constituent elements will be described below.

Communicator 210 performs the device-to-device communication with vehicle 100, 310, or 320 to transmit and receive information. Communicator 210 may transmit, by the device-to-device communication, the emergency information to surrounding vehicles capable of performing communication. Communicator 210 may also transmit, by the device-to-device communication, the emergency information to a vehicle which is predicted to travel on the scheduled route. The vehicle which is predicted to travel on the scheduled route may be identified by controller 220. Communicator 210 may be realized by communication IF for performing the device-to-device communication.

Controller 220 generates the emergency information including schedule information on the scheduled route. The emergency information generated by controller 220 may include the travel speed and the current location of emergency vehicle 200 when controller 220 generates the emergency information. Controller 220 searches for a vehicle which is traveling on the scheduled route and is in a state capable of performing communication. In the search described above, controller 220 may search for traffic light 400 capable of performing communication. When controller 220 finds vehicle 100, controller 220 may transmit the emergency information to vehicle 100 via communicator 210. When controller 220 cannot find vehicle 100 (that is, when a vehicle capable of performing communication is non-existent), controller 220 may transmit the emergency information to traffic light 400 via communicator 210.

Driver 230 is an operator which performs operations on the movement of emergency vehicle 200 such as the travel, the steering, the braking, and the like of emergency vehicle 200. Driver 230 may be realized, for example, by an engine, a motor, steering, a brake, and the like.

Storage 240 may store the emergency information generated by controller 220. Storage 240 may store the emergency information or may transmit the stored emergency information to an external device. Storage 240 may be realized, for example, by a hard disk drive (HDD), a solid state drive (SSD), and the like.

### [Traffic Light]

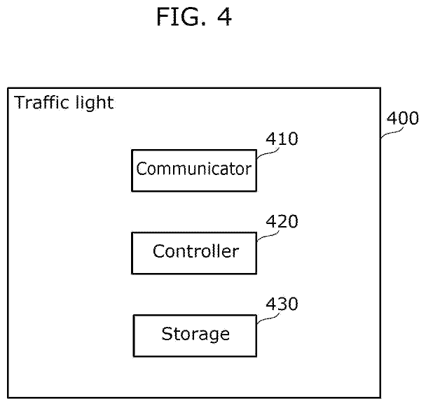

FIG. 4 is a diagram showing an example of the configuration of the traffic light in Embodiment 1.

As shown in FIG. 4, traffic light 400 includes communicator 410, controller 420, and storage 430. A processor uses a memory to execute predetermined programs, and thus the functions of traffic light 400 can be realized. The constituent elements will be described below.

Communicator 410 performs the device-to-device communication with emergency vehicle 200 or vehicle 100, 310, or 320 to transmit and receive information. Communicator 410 acquires the emergency information from another vehicle. Here, communicator 410 may directly acquire the emergency information from emergency vehicle 200 or may acquire the emergency information via vehicle 100, 310, or 320. Then, communicator 410 may transmit, by the device-to-device communication, the emergency information to a vehicle which is predicted to travel on the scheduled route. The vehicle which is predicted to travel on the scheduled route may be identified by controller 420. Communicator 410 may transmit, by the device-to-device communication, the emergency information to vehicle 100, 310, or 320 capable of performing communication. Communicator 410 may be realized by communication IF for performing the device-to-device communication.

Controller 420 may identify the scheduled route of emergency vehicle 200 based on the emergency information acquired by communicator 110. When the route information included in the emergency information indicates the scheduled route, controller 420 may identify the scheduled route by acquiring the route information. When the route information included in the emergency information indicates the destination of emergency vehicle 200, controller 420 may identify the scheduled route by estimating a route up to the destination. The route up to the destination which is estimated may include a plurality of patterns of routes. Controller 420 searches for another vehicle which is traveling on the scheduled route identified and is in a state capable of performing communication.

Storage 430 stores the emergency information received by communicator 410. Storage 430 may delete the stored emergency information after emergency vehicle 200 passes through a route on which traffic light 400 is arranged. Storage 430 may be realized, for example, by a hard disk drive (HDD), a solid state drive (SSD), and the like.

Since vehicles 310 and 320 have the same configuration as vehicle 100, the description thereof is omitted.

### [Operation of Notification System and Like]

The operation of the notification system configured as described above will then be described.

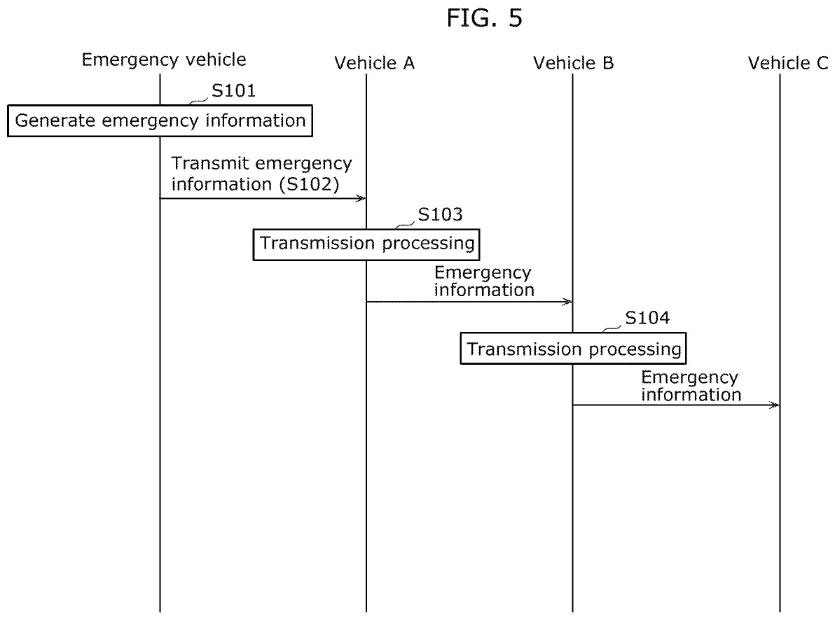

FIG. 5 is a sequence diagram showing an example of notification processing performed by the notification system in Embodiment 1. In FIG. 5, vehicles 100, 310, and 320 are referred to as vehicles A, B, and C, respectively.

First, when an emergency event occurs and thus emergency vehicle 200 travels in an emergency, emergency vehicle 200 generates the emergency information (S101).

Then, emergency vehicle 200 transmits the emergency information (S102). For example, emergency vehicle 200 finds vehicle A capable of performing communication, and transmits the emergency information to vehicle A.

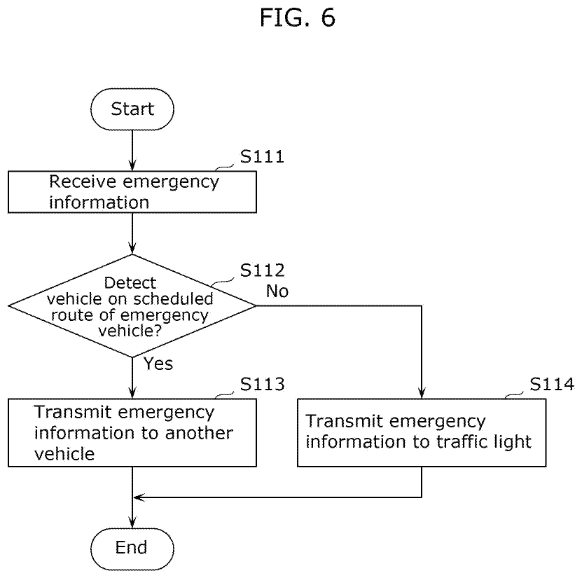

Vehicle A to which the emergency information has been transmitted performs transmission processing (S103). In this way, vehicle A transmits the emergency information to vehicle B. The details of the transmission processing will be described later with reference to FIG. 6.

Vehicle B to which the emergency information has been transmitted performs transmission processing (S104). In this way, vehicle B transmits the emergency information to vehicle C. The transmission processing is the same as that in step S103.

When as with vehicles A and B, vehicle C searches for a subsequent vehicle capable of performing communication to find the subsequent vehicle, vehicle C transmits the emergency information to the subsequent vehicle. As described above, when the vehicle finds a subsequent vehicle capable of performing communication, the vehicle transmits the emergency information to the subsequent vehicle, and this processing is repeated. For example, this processing may be repeated until emergency vehicle 200 reaches the destination (for example, until a scheduled time at which emergency vehicle 200 reaches the destination).

FIG. 6 is a flowchart showing an example of the transmission processing performed by the vehicle in Embodiment 1. Although here, the transmission processing is described as processing performed by vehicle A, the same processing is performed in vehicles B and C.

Vehicle A receives the emergency information (S111).

Vehicle A analyzes the emergency information to identify the scheduled route of emergency vehicle 200, and determines whether another vehicle is present on the scheduled route (S112). In other words, vehicle A searches for another vehicle which is traveling on the scheduled route identified and is in a state capable of performing communication, and determines whether the vehicle described above is present.

When vehicle A determines that the vehicle is present on the scheduled route (yes in S112), vehicle A transmits the emergency information to the vehicle (for example, vehicle B) by the device-to-device communication (S113).

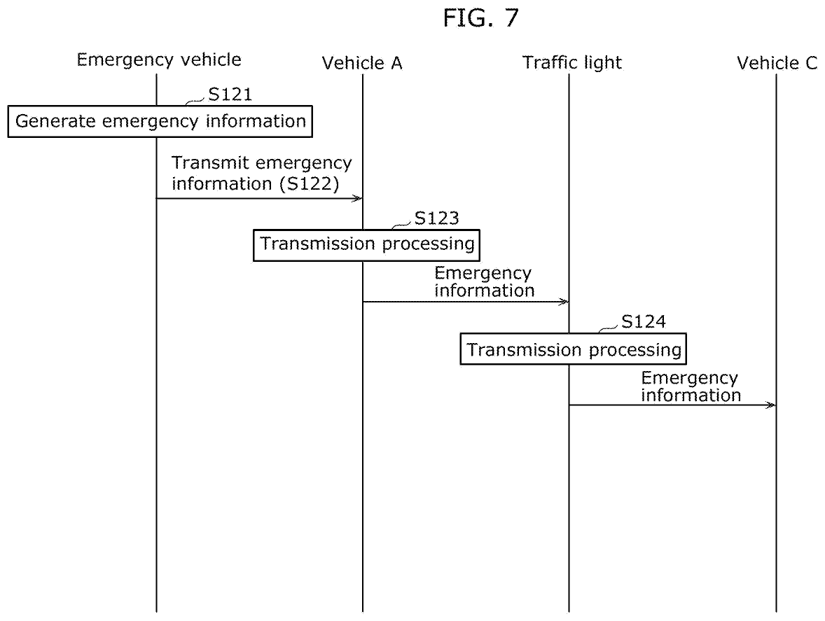

When vehicle A determines that the vehicle is non-existent on the scheduled route (no in S112), vehicle A transmits the emergency information to traffic light 400 (S114). Processing when the emergency information is transmitted to traffic light 400 will be described later with reference to FIG. 7.

FIG. 7 is a sequence diagram showing another example of the notification processing performed by the notification system in Embodiment 1.

First, when an emergency event occurs and thus emergency vehicle 200 travels in an emergency, emergency vehicle 200 generates the emergency information (S121).

Then, emergency vehicle 200 transmits the emergency information (S122). For example, emergency vehicle 200 finds vehicle A capable of performing communication, and transmits the emergency information to vehicle A. Here, when emergency vehicle 200 cannot find vehicle A, emergency vehicle 200 may transmit the emergency information to traffic light 400 near emergency vehicle 200.

Vehicle A to which the emergency information has been transmitted performs transmission processing (S123). In this way, vehicle A transmits the emergency information to vehicle B. The details of the transmission processing are the same as the details of the transmission processing described in FIG. 6. When in step S112 of the transmission processing, vehicle A determines that another vehicle is non-existent on the scheduled route, vehicle A transmits the emergency information to traffic light 400 (S114).

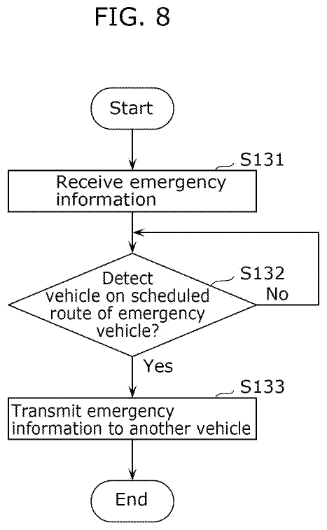

Traffic light 400 to which the emergency information has been transmitted performs transmission processing (S124). In this way, traffic light 400 transmits the emergency information to vehicle C. The details of the transmission processing in traffic light 400 will be described later with reference to FIG. 8.

FIG. 8 is a flowchart showing an example of the transmission processing performed by the traffic light in Embodiment 1.

Traffic light 400 receives the emergency information (S131).

Traffic light 400 analyzes the emergency information to identify the scheduled route of emergency vehicle 200, and determines whether another vehicle is present on the scheduled route (S132). In other words, traffic light 400 searches for another vehicle which is traveling on the scheduled route identified and is in a state capable of performing communication, and determines whether the vehicle described above is present. Traffic light 400 may determine whether another vehicle which is to pass through the scheduled route is present. In other words, traffic light 400 may search for another vehicle which is to travel on the scheduled route identified and is in a state capable of performing communication, and determine whether the vehicle described above is present. For example, traffic light 400 may communicate with a vehicle capable of performing communication to acquire the scheduled route of the vehicle from the vehicle, and thereby determine whether the vehicle is to pass through the scheduled route.

When traffic light 400 determines that another vehicle is present on the scheduled route or that another vehicle which is to pass through the scheduled route is present (yes in S132), traffic light 400 transmits the emergency information to the vehicle described above (for example, vehicle B) by the device-to-device communication (S133).

When vehicle A determines that another vehicle is non-existent on the scheduled route or that another vehicle which is to pass through the scheduled route is non-existent (no in S132), the processing returns to step S132.

In this way, when the scheduled route of the emergency vehicle includes a route from a first route to a fourth route, traffic light 400 acquires the emergency information from a first vehicle traveling from the first route to the second route and holds the emergency information, transmits the emergency information to a second vehicle traveling from the third route to the fourth route, and thereby can notify the emergency information to the vehicle which is to travel on the scheduled route. The second route and the third route may be the same route.

An example of avoidance processing performed by the vehicle which has received the emergency information will then be described.

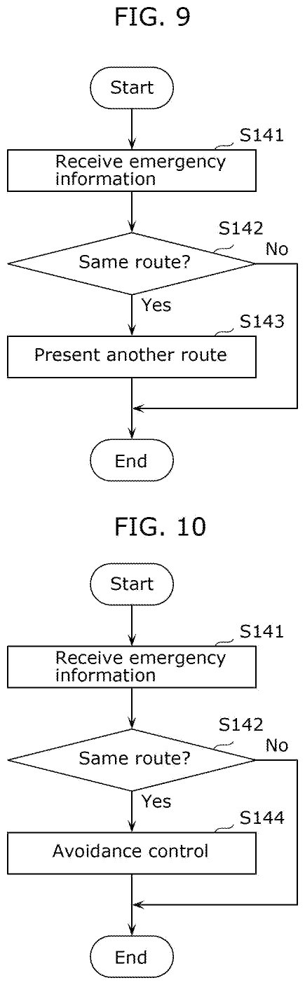

FIG. 9 is a flowchart showing an example of the avoidance processing performed by the vehicle in Embodiment 1. Although here, the avoidance processing is described as processing performed by vehicle A, the same processing is performed in vehicles B and C.

Vehicle A receives the emergency information (S114).

Vehicle A analyzes the emergency information to identify the scheduled route of emergency vehicle 200, and determines whether vehicle A is to travel on the scheduled route (S142).

When vehicle A determines that vehicle A is to travel on the scheduled route (yes in S142), another route on which vehicle A is to travel is presented to the user (S143).

When vehicle A determines that vehicle A is not to travel on the scheduled route (no in S142), the processing is completed.

FIG. 10 is a flowchart showing another example of the avoidance processing performed by the vehicle in Embodiment 1. Although here, the avoidance processing is described as processing performed by vehicle A, the same processing is performed in vehicles B and C.

Processing in steps S141 and S142 in the example of FIG. 10 is the same as the processing in steps S141 and S142 in the example of FIG. 9.

When vehicle A determines that vehicle A is to travel on the scheduled route (yes in S142), avoidance control for stopping vehicle A on a shoulder is performed (S144). In the avoidance control, vehicle A may move to a route different from the scheduled route.

When vehicle A determines that vehicle A is not to travel on the scheduled route (no in S142), the processing is completed.

### [Effects and Like]

As described above, in the control method for vehicle 100 according to the present embodiment, vehicle 100 acquires, from emergency vehicle 200 (or another vehicle), the emergency information that includes the route information on the scheduled route on which emergency vehicle 200 travels in an emergency. The vehicle transmits, by the device-to-device communication, the emergency information to vehicle 310 which is predicted to travel on the scheduled route.

In this way, the emergency information including the information on the scheduled route on which emergency vehicle 200 travels in an emergency is transmitted by the device-to-device communication to vehicle 310 which is predicted to travel on the scheduled route. Hence, it is possible to notify the emergency information to only vehicle 310 which is highly likely to obstruct the emergency travel of emergency vehicle 200. Therefore, the device-to-device communication is utilized, and thus it is possible to effectively notify surrounding vehicles of the scheduled route on which emergency vehicle 200 travels.

The emergency information further includes the lane information indicating the lane in which emergency vehicle 200 is traveling in an emergency. Vehicle 310 is a moving body which is traveling in the same lane as the lane. Hence, it can be determined that vehicle 310 which is traveling in the same lane as the lane in which emergency vehicle 200 is traveling in an emergency is highly likely to obstruct the emergency travel.

The emergency information also includes the travel speed and the current location of emergency vehicle 200. Furthermore, in the control method, based on the emergency information, the estimated time at which vehicle 100 will be overtaken by emergency vehicle 200 is estimated, and before the estimated time, vehicle 100 is stopped on the shoulder of a road on which vehicle 100 is traveling. Hence, before vehicle 100 is overtaken by emergency vehicle 200, vehicle 100 can be moved to the shoulder which does not obstruct the travel of emergency vehicle 200.

The emergency information also includes the travel speed and the current location of emergency vehicle 200. Furthermore, in the control method, based on the emergency information, the estimated time at which vehicle 100 will be overtaken by emergency vehicle 200 is estimated, and before the estimated time, vehicle 100 is moved to a route different from the scheduled route. Hence, before vehicle 100 is overtaken by emergency vehicle 200, vehicle 100 can be moved to the route which does not obstruct the travel of emergency vehicle 200.

In the transmission of the emergency information, when another vehicle is non-existent, the emergency information is transmitted to traffic light 400 near vehicle 100. Hence, the emergency information is notified to traffic light 400, and thus, for example, it is possible to cause traffic light 400 to notify the emergency information to another vehicle which thereafter passes through an area near traffic light 400 (within the communication range thereof).

When in the transmission of the emergency information, vehicle 100 cannot communicate with another vehicle or traffic light 400, vehicle 100 is moved within the communication range of traffic light 400. Hence, the received emergency information can be notified to traffic light 400.

When in the transmission of the emergency information, vehicle 100 cannot communicate with another vehicle or traffic light 400, a presentation prompting the user to move vehicle 100 within the communication range of traffic light 400 is provided to the user. Hence, it is possible to prompt the user to perform the operation for notifying the received emergency information to the roadside device.

### Embodiment 2

A notification system in Embodiment 2 will be described.

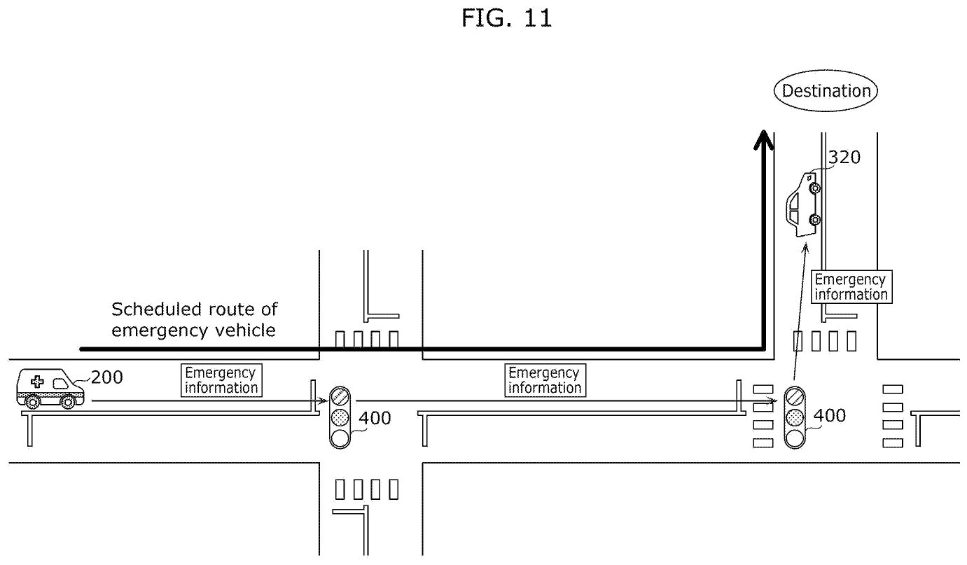

FIG. 11 is a diagram showing an example of the configuration of the notification system in Embodiment 2.

The notification system in the present embodiment is an example of a case where emergency vehicle 200 notifies the emergency information to vehicle 320 via vehicle 100 and traffic lights 400, and is also an example of a case where signal control is performed when traffic lights 400 receive the emergency information.

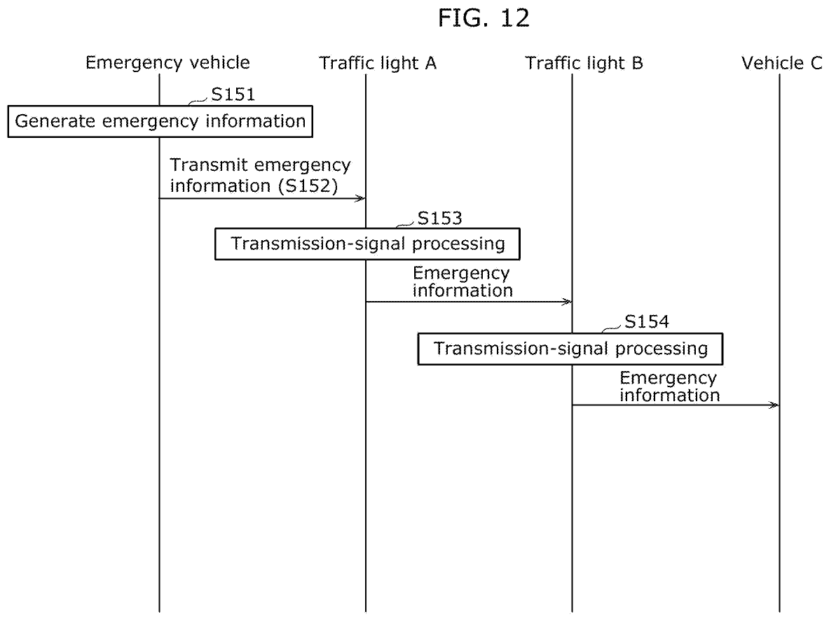

FIG. 12 is a sequence diagram showing an example of notification processing performed by the notification system in Embodiment 2. In FIG. 12, two traffic lights 400 are referred to as traffic light A and traffic light B, respectively.

First, when an emergency event occurs and thus emergency vehicle 200 travels in an emergency, emergency vehicle 200 generates the emergency information (S151).

Then, emergency vehicle 200 transmits the emergency information (S152). For example, emergency vehicle 200 finds traffic light A capable of performing communication, and transmits the emergency information to traffic light A.

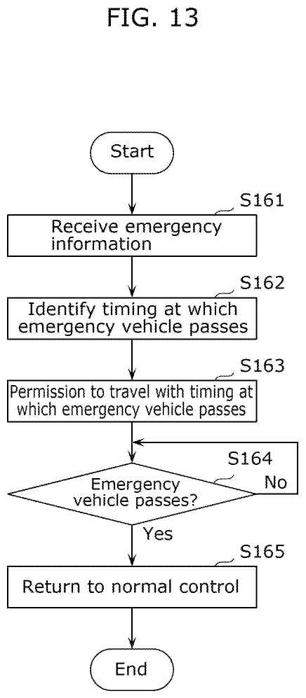

Traffic light A to which the emergency information has been transmitted performs transmission processing and signal processing (S153). In this way, traffic light A transmits the emergency information to traffic light B. The transmission processing is the same as the processing in steps S131 to S133 described with reference to FIG. 8. The signal processing will be described later with reference to FIG. 13.

Traffic light B to which the emergency information has been transmitted performs transmission processing and signal processing (S154). In this way, traffic light B transmits the emergency information to vehicle C. The transmission processing and the signal processing are the same as the processing in step S153.

As with vehicles A and B, vehicle C searches for a subsequent vehicle capable of performing communication, and when vehicle C finds the subsequent vehicle, vehicle C transmits the emergency information to the vehicle described above. As described above, when the vehicle finds a subsequent vehicle capable of performing communication, the vehicle transmits the emergency information to the subsequent vehicle, and this processing is repeated. For example, this processing may be repeated until emergency vehicle 200 reaches the destination (for example, until a scheduled time at which emergency vehicle 200 reaches the destination).

FIG. 13 is a flowchart showing an example of the signal processing performed by the traffic light in Embodiment 2. Although here, the signal processing is described as processing performed by traffic light A, the same processing is performed in traffic light B.

Traffic light A receives the emergency information (S161).

Traffic light A analyzes the emergency information to identify the scheduled route of emergency vehicle 200 and the travel speed and the position of emergency vehicle 200 when the emergency information is generated, and calculates and identifies timing at which emergency vehicle 200 passes through traffic light A (S162). When the emergency information includes the timing at which emergency vehicle 200 passes through traffic light A, traffic light A analyzes the emergency information to identify the timing.

Traffic light A switches to a signal indicating permission to travel with the timing at which emergency vehicle 200 passes through traffic light A (S163). In other words, traffic light A regulates its signal to the signal indicating permission to travel. For example, traffic light A performs control such that the signal turns green with the timing.

Traffic light A determines whether emergency vehicle 200 passes through the position of traffic light A (S164). Traffic light A may determine whether emergency vehicle 200 passes through the position by whether the current time exceeds the timing identified (that is, yes in step S164). When the current time does not exceed the timing identified (that is, no in step S164), traffic light A may determine that emergency vehicle 200 does not pass through the position of traffic light A. Traffic light A may make the determination in step S164 by analyzing a siren detected with a microphone or an image shot with a camera. The microphone or the camera in this case may be included in traffic light A or may be arranged near traffic light A.

When traffic light A determines that emergency vehicle 200 passes through the position of traffic light A (yes in S164), the signal control of traffic light A is returned to its original state (S165). In other words, traffic light A releases the regulation of permission to travel.

When traffic light A determines that emergency vehicle 200 does not pass through the position of traffic light A (no in S164), the processing returns to step S164.

### [Effects and Like]

As described above, in the control method for traffic light 400 according to the present embodiment, traffic light 400 acquires, from emergency vehicle 200 (or another vehicle), the emergency information indicating that emergency vehicle 200 is approaching. Traffic light 400 presents the signal indicating permission to travel with the timing at which emergency vehicle 200 passes through traffic light 400. In this way, traffic light 400 presents the signal indicating permission to travel with the timing at which emergency vehicle 200 passes through traffic light 400, and thus emergency vehicle 200 easily passes through an intersection where traffic light 400 is installed without lowering the travel speed. Hence, the smooth movement of emergency vehicle 200 can be facilitated.

The emergency information includes the travel speed information and the current location information of emergency vehicle 200. In the control method, the timing is further calculated based on the travel speed information and the current location information. Hence, with the timing at which emergency vehicle 200 passes through traffic light 400, traffic light 400 can present the signal indicating permission to travel.

### Embodiment 3

A notification system in Embodiment 3 will be described.

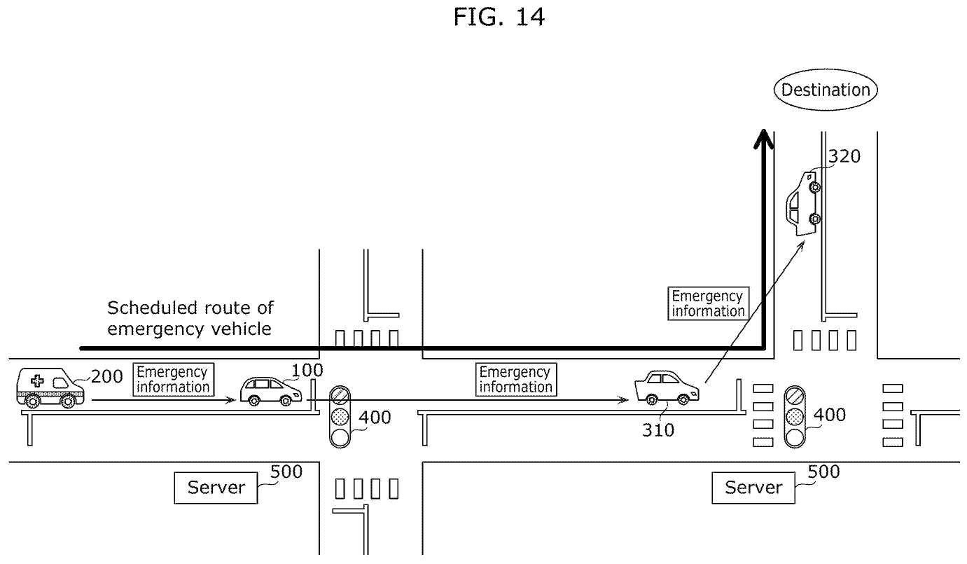

FIG. 14 is a diagram showing an example of the configuration of the notification system in Embodiment 3.

The notification system in the present embodiment is an example of a case where when emergency vehicle 200 transmits the emergency information to vehicle 100 or the like, vehicle 100 or the like confirms the authorization of the emergency information to perform transmission processing or the like. The notification system in the present embodiment further includes a plurality of servers 500 in the configuration of the notification system in Embodiment 1.

Servers 500 may be configured such that all servers 500 are connected to each other via a network, such that all servers 500 are directly connected to be able to communicate with each other, or such that part of servers 500 are connected via a network and the other parts are directly connected to be able to communicate with each other. Although examples of the network include the Internet, a carrier network of cellular phones, and the like, the network may be formed by any communication line or network. Servers 500 manage a distributed ledger which stores a blockchain. Servers 500 may be any one of a public type, a private type, and a consortium type.

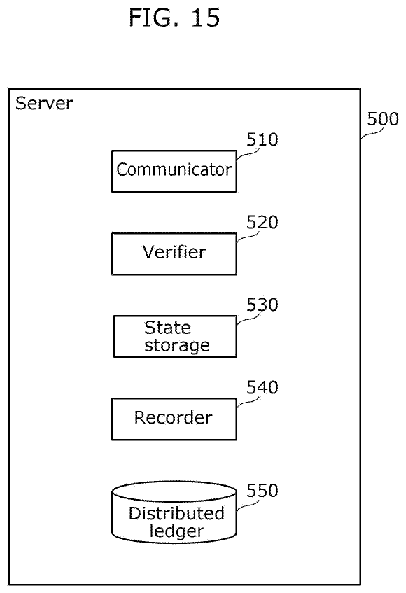

FIG. 15 is a diagram showing an example of the configuration of the server in Embodiment 3.

As shown in FIG. 15, server 500 includes communicator 510, verifier 520, state storage 530, recorder 540, and distributed ledger 550. A processor uses a memory to execute predetermined programs, and thus server 500 can be realized. The constituent elements of server 500 will be described below.

Communicator 510 receives transaction data including authority information from emergency vehicle 200 or a terminal owned by the user of emergency vehicle 200. Communicator 510 may transmit the received transaction data to other servers 500.

Communicator 510 may exchange data other than the transaction data with other servers 500. Communicator 510 may also exchange data with a device (terminal) other than other servers 500.

As described above, communicator 510 communicates with other servers 500. The communication described above may be performed by transport layer security (TLS), and a cryptographic key for TLS communication may be held in communicator 510.

When communicator 510 receives the transaction data, verifier 520 verifies the authorization of the transaction data. For example, verifier 520 verifies whether an electronic signature generated in a correct manner is provided to the transaction data received by communicator 510. The verification described above may be skipped.

Verifier 520 executes, together with other servers 500, a consensus algorithm for agreeing on the authorization of the transaction data.

Here, as the consensus algorithm, practical byzantine fault tolerance (PBFT) may be used or another known consensus algorithm may be used. Examples of the known consensus algorithm include proof of work (PoW), proof of stake (PoS), and the like. When PBFT is used as the consensus algorithm, verifier 520 receives, from each of other servers 500, a report indicating whether the verification of the transaction data is successful, and determines whether the number of reports exceeds a predetermined number. Then, it is sufficient that when the number of reports exceeds the predetermined number, verifier 520 determines that the authorization of the transaction data is verified by the consensus algorithm.

When verifier 520 confirms the authorization of the transaction data, verifier 520 records the transaction data in recorder 540.

State storage 530 is a storage which stores the latest data in distributed ledger 550. The data stored in state storage 530 can be changed or deleted by a computer. State storage 530 may store the transaction data before being stored in distributed ledger 550. State storage 530 may store the transaction data received by communicator 510. State storage 530 may temporarily store the data described above.

Recorder 540 includes, in a block, the transaction data whose authorization has been verified by verifier 520, stores it in distributed ledger 550, and thereby records the transaction data.

Distributed ledger 550 may be formed inside recorder 540.

Distributed ledger 550 stores the transaction data including the authority information. The authority information includes an emergency ID. The emergency ID is information indicating that emergency vehicle 200 provides authorized emergency information.

### [Operation of Notification System and Like]

The operation of the notification system configured as described above will then be described.

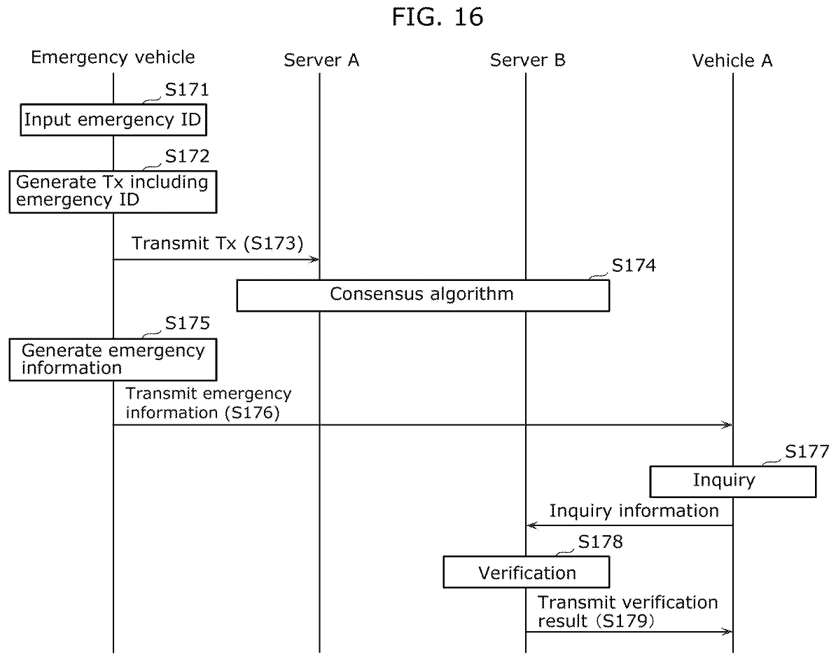

FIG. 16 is a sequence diagram showing an example of notification processing performed by the notification system in Embodiment 3. In FIG. 16, two servers 500 are referred to as server A and server B, respectively. Vehicle 100 is referred to as vehicle A.

Emergency vehicle 200 receives an input of the emergency ID (S171).

Emergency vehicle 200 generates the transaction data (Tx) including the emergency ID (S172). The emergency ID may be information which is indicated by a character string or the like that is previously issued by a predetermined agency, and in this case, a terminal in the predetermined agency may generate the transaction data (Tx) including the emergency ID.

Emergency vehicle 200 transmits the transaction data (Tx) to server A (S173).

Steps S171 to S173 do not need to be performed by emergency vehicle 200 and may be performed by the terminal owned by the user of emergency vehicle 200.

Then, servers A and B execute the consensus algorithm, generate the block including the transaction data, and store it in each distributed ledger 550 (S174).

Then, when an emergency event occurs and thus emergency vehicle 200 travels in an emergency, emergency vehicle 200 generates the emergency information (S175). The emergency information generated here further includes the emergency ID in addition to the information described in the above embodiments. The emergency ID may be fixedly associated with emergency vehicle 200 or may be temporarily associated with another vehicle. When the emergency ID is temporarily associated with another vehicle, a function capable of generating the emergency information including the emergency ID by causing a reading device in the vehicle described above to read a card including the emergency ID may be provided to the vehicle described above.

Then, emergency vehicle 200 transmits the emergency information (S176). For example, emergency vehicle 200 finds vehicle A capable of performing communication, and transmits the emergency information to vehicle A.

Vehicle A transmits inquiry information for inquiring of server B (or server A) whether the emergency ID included in the emergency information is authorized information (S177). In this way, vehicle A confirms that the authority information indicating that emergency vehicle 200 is an authorized emergency vehicle is stored in the blockchain.

Then, when server B (or server A) receives the inquiry information, server B (or server A) verifies the authorization of the emergency ID by determining whether the emergency ID included in the inquiry information is stored in the blockchain of distributed ledger 550 (S178).

Server B transmits the result of the verification to vehicle A (S179). When server B determines that the emergency ID is stored in the blockchain of distributed ledger 550, server B transmits, to vehicle A, the result of the verification indicating that the emergency ID is authorized. When server B determines that the emergency ID is not stored in the blockchain of distributed ledger 550, server B transmits, to vehicle A, the result of the verification indicating that the emergency ID is not authorized.

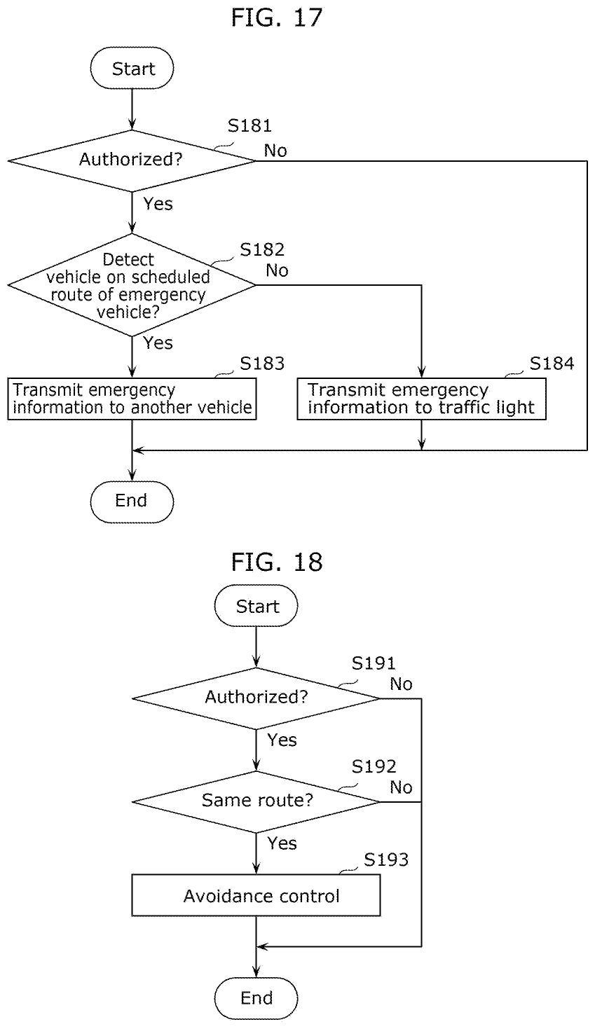

FIG. 17 is a flowchart showing an example of the transmission processing performed by the vehicle in Embodiment 3. Although here, the transmission processing is described as processing performed by vehicle A, the same processing is performed in vehicles B and C. The processing in FIG. 17 is processing which is performed after vehicle A receives the result of the verification transmitted in step S179.

Vehicle A determines whether the result of the verification which is received is authorized (S181).

When vehicle A determines that the result of the verification is authorized (yes in S181), vehicle A analyzes the emergency information to identify the scheduled route of emergency vehicle 200, and determines whether another vehicle is present on the scheduled route (S182). In other words, vehicle A searches for another vehicle which is traveling on the scheduled route identified and is in a state capable of performing communication, and determines whether the vehicle described above is present.

When vehicle A determines that the vehicle is present on the scheduled route (yes in S182), vehicle A transmits the emergency information to the vehicle (for example, vehicle B) by the device-to-device communication (S183).

When vehicle A determines that the vehicle is non-existent on the scheduled route (no in S182), vehicle A transmits the emergency information to traffic light 400 (S184).

When vehicle A determines that the result of the verification which is received is not authorized (no in S181), the processing is completed. As processing when the emergency information is transmitted to traffic light 400, the same processing as the processing in FIG. 7 may be performed.

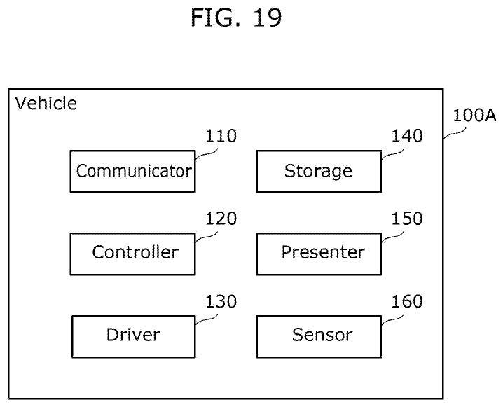

FIG. 18 is a flowchart showing an example of avoidance processing performed by the vehicle in Embodiment 3. The processing in FIG. 18 is processing which is performed after vehicle A receives the result of the verification transmitted in step S179.

Vehicle A determines whether the result of the verification which is received is authorized (S191).

When vehicle A determines that the result of the verification is authorized (yes in S191), vehicle A analyzes the emergency information to identify the scheduled route of emergency vehicle 200, and determines whether vehicle A is to travel on the scheduled route (S192).

When vehicle A determines that vehicle A is to travel on the scheduled route (yes in S192), avoidance control for stopping vehicle A on a shoulder is performed (S193). In the avoidance control, vehicle A may move to a route different from the scheduled route or may present, to the user, another route on which vehicle A is to travel.

When vehicle A determines that the result of the verification which is received is not authorized (no in S191) or when vehicle A determines that vehicle A is not to travel on the scheduled route (no in S192), the processing is completed.

### [Effects and Like]

As described above, in the control method for vehicle 100 according to the present embodiment, when vehicle 100 acquires the emergency information, vehicle 100 verifies whether the authority information indicating that emergency vehicle 200 is an authorized emergency vehicle is stored in the blockchain. In the transmission of the emergency information, when the authority information is stored in the blockchain, the emergency information is transmitted to another vehicle or traffic light 400. Hence, it is possible to suppress the performance of control for prioritizing the travel of a vehicle which transmits, based on unauthorized emergency information, the unauthorized emergency information.

### Embodiment 4

A notification system in Embodiment 4 will be described.

In the notification system in the present embodiment, a transmission function in the device-to-device communication is restricted, and in other words, the notification system is an example of a case where a restriction is imposed such that transmission cannot be performed.

### [Vehicle]

FIG. 19 is a diagram showing an example of the configuration of a vehicle in Embodiment 4.

As shown in FIG. 19, vehicle 100A includes communicator 110, controller 120, driver 130, storage 140, and presenter 150, and further includes sensor 160. Vehicle 100A differs from vehicle 100 in that vehicle 100A further includes sensor 160.

For example, sensor 160 may be a camera which shoots the surrounding area of vehicle 100A or may be an object detection sensor (for example, LiDAR) which detects an object around vehicle 100A. Sensor 160 may be various types of sensors which detect the state of the surrounding environment of vehicle 100A or may be various types of sensors which detect the state of travel of vehicle 100A. Sensor 160 generates sensor information which includes the result of detection of the state.

In a normal state, communicator 110 is restricted such that the transmission function cannot be used. In the normal state, communicator 110 can use a reception function.

When controller 120 detects a trigger, controller 120 releases the restriction of the transmission function on communicator 110. For example, when controller 120 receives the emergency information from emergency vehicle 200, controller 120 may release the restriction of the transmission function on communicator 110. In other words, the trigger may be the reception of the emergency information. The trigger is not limited to the reception of the emergency information, and may be the reception of flagged information indicating a trigger, may be the detection of occurrence of an earthquake performed by detecting a vibration larger than a predetermined amplitude, or may be the reception of information indicating the occurrence of a disaster from an external device. In a state where the restriction of the transmission function is released, controller 120 may transmit the sensor information via communicator 110 to another vehicle by the device-to-device communication.

When the trigger is the reception of the emergency information, the flagged information, or the like from another vehicle, if the number of times the information serving as the trigger is acquired from the same vehicle exceeds a predetermined number of times, controller 120 does not need to release the restriction of the transmission function in the device-to-device communication. When the trigger is the reception of the emergency information, the flagged information, or the like from another vehicle, if a predetermined time has elapsed since the time at which the information was generated or the time at which the information was first transmitted or received, controller 120 does not need to release the restriction of the transmission function in the device-to-device communication. In this way, when the trigger is highly likely to be unauthorized, it is possible to suppress the release of the restriction of the transmission function in the device-to-device communication.

### [Operation and Like]

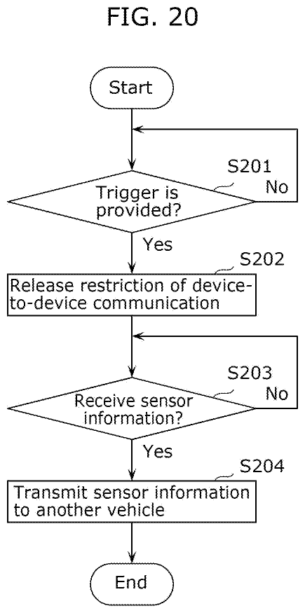

FIG. 20 is a flowchart showing an example of an operation performed by the vehicle in Embodiment 4.

Vehicle 100A determines whether the trigger is provided (S201).

When vehicle 100A determines that the trigger is provided (yes in S201), vehicle 100A releases the restriction of the transmission function in the device-to-device communication (S202).

Then, vehicle 100A determines whether the sensor information is received (S203).

When vehicle 100A determines that the sensor information is received (yes in S203), vehicle 100A transmits the received sensor information to another vehicle (S204).

The sensor information may be the emergency information. When the trigger is the reception of the emergency information and the sensor information is the emergency information, the emergency information may be transmitted to another vehicle without the determination in step S203 being made. As processing for receiving the emergency information and transmitting it to another vehicle, the processing in the flowchart described with reference to FIG. 6 may be performed.

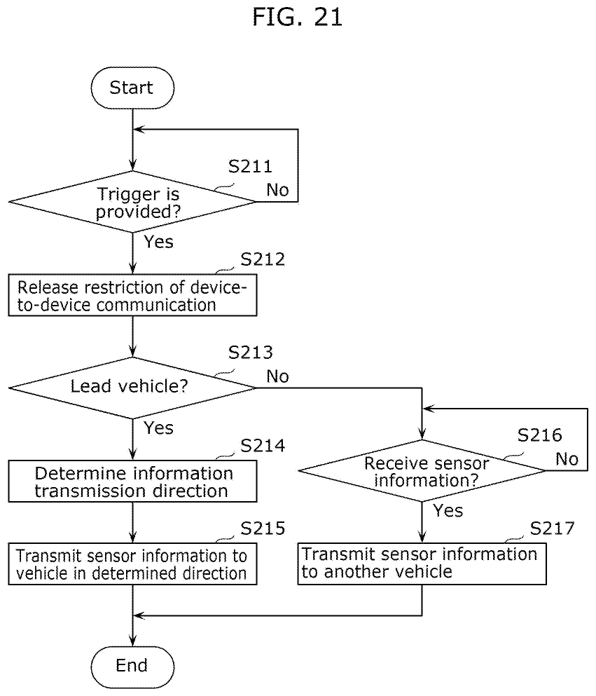

FIG. 21 is a flowchart showing another example of the operation performed by the vehicle in Embodiment 4.

Vehicle 100A determines whether the trigger is provided (S211).

When vehicle 100A determines that the trigger is provided (yes in S211), vehicle 100A releases the restriction of the transmission function in the device-to-device communication (S212).

Then, vehicle 100A determines whether vehicle 100A is the lead vehicle (S213). When a vehicle which is traveling ahead of vehicle 100A in the direction of travel is not found or when a vehicle which is traveling ahead of vehicle 100A in the direction of travel is a predetermined distance or more away from vehicle 100A, vehicle 100A may determine that vehicle 100A is the lead vehicle.

When vehicle 100A determines that vehicle 100A is the lead vehicle (yes in S213), vehicle 100A determines to which one of a forward direction and a backward direction relative to the direction of travel an information transmission direction is set (S214).

Vehicle 100A transmits the sensor information to another vehicle in the direction determined in step S214 (S215).

When vehicle 100A determines that vehicle 100A is not the lead vehicle (no in S213), vehicle 100A determines whether the sensor information is received (S216).

When vehicle 100A determines that the sensor information is received (yes in S216), vehicle 100A transmits the sensor information to another vehicle (S217).

When vehicle 100A determines that the sensor information is not received (no in S216), the processing returns to step S216.

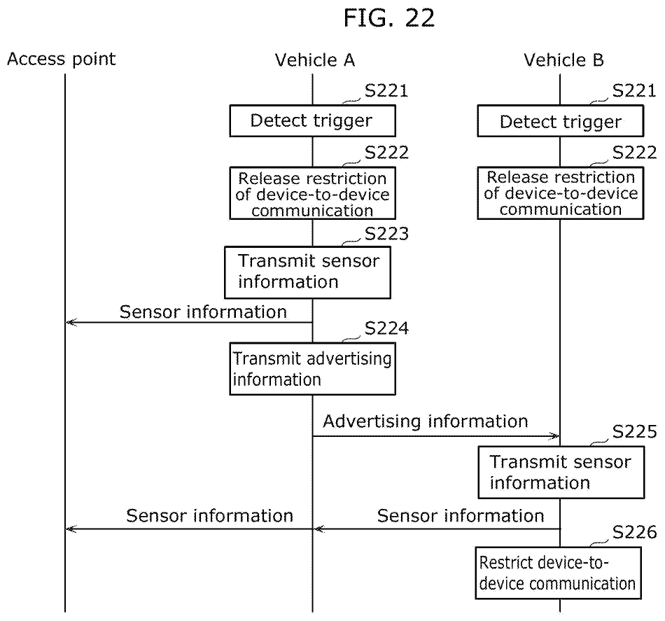

FIG. 22 is a sequence diagram showing an example of an operation performed by the notification system in Embodiment 4.

An access point in FIG. 22 is a device which can communicate with vehicle A. Vehicle A is an example of vehicle 100A. Vehicle B is an example of another vehicle.

Vehicle A detects the trigger (S221). For example, vehicle A receives the emergency information to detect the trigger.

Then, vehicle A releases the restriction of the transmission function in the device-to-device communication (S222).

Then, vehicle A transmits the sensor information to the access point (S223).

Then, vehicle A transmits, to vehicle B, by the device-to-device communication, advertising information indicating that vehicle A can perform transmission to the access point (S224).

Then, vehicle B detects the trigger (S221). For example, vehicle B receives the emergency information to detect the trigger.

Then, vehicle B releases the restriction of the transmission function in the device-to-device communication (S222).

Vehicle B may receive the advertising information to detect the trigger. In other words, when vehicle B receives the advertising information, vehicle B may release the restriction of the transmission function in the device-to-device communication.

Vehicle B transmits the sensor information to vehicle A by the device-to-device communication (S225), and when vehicle A receives the sensor information from vehicle B, vehicle A transmits the received sensor information to the access point.

When vehicle B transmits the sensor information to vehicle A, vehicle B restricts the transmission function in the device-to-device communication (S226).

In this way, even when vehicle B does not have the function of communicating with the access point, vehicle B can transmit the sensor information via vehicle A to the access point.

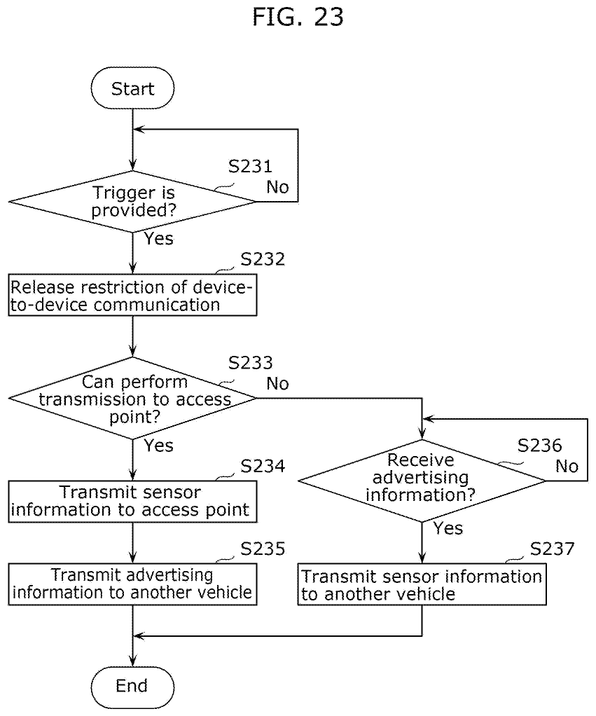

FIG. 23 is a flowchart showing another example of the operation performed by the vehicle in Embodiment 4.

Vehicle 100A determines whether the trigger is provided (S231).

When vehicle 100A determines that the trigger is provided (yes in S231), vehicle 100A releases the restriction of the transmission function in the device-to-device communication (S232).

Then, vehicle 100A determines whether vehicle 100A can perform transmission to the access point (S233).

When vehicle 100A determines that vehicle 100A can perform transmission to the access point (yes in S233), vehicle 100A transmits the sensor information to the access point (S234).

Vehicle 100A transmits the advertising information to another vehicle (S235).

When vehicle 100A determines that vehicle 100A cannot perform transmission to the access point (no in S233), vehicle 100A determines whether the advertising information is received (S236).

When vehicle 100A determines that the advertising information is received (yes in S236), vehicle 100A transmits the sensor information to a vehicle which transmits the advertising information (S237).

When vehicle 100A determines that the sensor information is not received (no in S236), the processing returns to step S236.

### [Effects and Like]

As described above, in the control method for vehicle 100A according to the present embodiment, vehicle 100A is restricted such that the transmission function in the device-to-device communication cannot be used, and when the trigger (for example, the emergency information) is received, the restriction of the transmission function is released. Hence, the transmission function in the device-to-device communication can be restricted to the transmission of the emergency information, and thus it is possible to reduce a communication load.

### [Other Embodiments and Like]

Although the present disclosure has been described above based on the above embodiments, the present disclosure is naturally not limited to the above embodiments. The following cases are also included in the present disclosure.

(1) Although in the embodiments described above, the moving body is a vehicle, for example, the moving body may be a ship or an aircraft.

(2) Each device in the embodiments described above is specifically a computer system which includes a microprocessor, a ROM, a RAM, a hard disk unit, a display unit, a keyboard, a mouse, and the like. In the RAM or the hard disk unit, computer programs are recorded. The microprocessor is operated according to the computer programs, and thus the device achieves its functions. Here, a computer program is formed by combining a plurality of command codes indicating instructions for a computer in order to achieve a predetermined function.

(3) A part or all of the constituent elements of each device in the embodiments described above may be formed using one system large scale integration (LSI) circuit. The system LSI circuit is an ultra-multifunctional LSI circuit manufactured by integrating a plurality of constituent portions on one chip, and is specifically a computer system which includes a microprocessor, a ROM, a RAM and the like. In the RAM, computer programs are recorded. The microprocessor is operated according to the computer programs, and thus the system LSI circuit achieves its functions.

The constituent elements of each device described above may be individually integrated into one chip or a part or all thereof may be integrated into one chip.

Although the system LSI circuit is described here, the circuit may be referred to as an IC, an LSI circuit, a super-LSI circuit, or an ultra-LSI circuit depending on the degree of integration. The method for forming the integrated circuit is not limited to LSI; the integrated circuit may be realized with a dedicated circuit or a general-purpose processor. A field programmable gate array (FPGA) which can be programmed after the manufacturing of an LSI circuit or a reconfigurable processor which allows the connection and setting of circuit cells inside an LSI circuit to be reconfigured may be utilized.

Furthermore, when a circuit integration technology that replaces LSI is developed due to advances in semiconductor technology or another derivative technology, such a technology may naturally be used to integrate a functional block. For example, application of a biotechnology is conceivable.

(4) A part or all of the constituent elements of each device described above may be formed using an IC card which is removable from the device or a single module. The IC card or the module is a computer system which includes a microprocessor, a ROM, a RAM, and the like. The IC card or the module may include the ultra-multifunctional LSI circuit described above. The microprocessor is operated according to computer programs, and thus the IC card or the module achieves its functions. The IC card or the module may be tamper-resistant.

(5) The present disclosure may be the methods described above. The present disclosure may also be computer programs which cause a computer to realize these methods or may also be digital signals formed by the computer programs.

The present disclosure may be the computer programs or the digital signals recorded in a computer-readable recording medium, and examples of the computer-readable recording medium include a flexible disk, a hard disk, a CD-ROM, an MO, a DVD, a DVD-ROM, a DVD-RAM, a Blu-ray (registered trademark) disc (BD), a semiconductor memory, and the like. The present disclosure may be the digital signals recorded in these recording media.

The present disclosure may be the computer programs or the digital signals which are transmitted via a telecommunications line, a wireless or wired communication line, a network such as the Internet, data broadcasting, or the like.

The present disclosure may be a computer system which includes a microprocessor and a memory, the memory may record the computer programs described above, and the microprocessor may be operated according to the computer programs.

The programs or the digital signals are recorded in the recording medium described above and are transferred or the programs or the digital signals are transferred via the network described above or the like, and thus the present disclosure may be practiced using another independent computer system.

(6) The embodiments and the variations described above may be combined.

### Industrial Applicability

The present disclosure can be utilized in a control method, a server, and a recording medium, and can be utilized in, for example, a control method, a moving body, a recording medium, and the like which can effectively notify surrounding vehicles that an emergency vehicle is traveling in an emergency.

1. A control method for a first moving body, the control method comprising:
acquiring, from a second moving body, emergency information that includes route information on a scheduled route on which an emergency vehicle travels in an emergency; and
transmitting, by device-to-device communication, the emergency information to a third moving body that is predicted to travel on the scheduled route.

2. The control method according to claim 1,
wherein the emergency information further includes lane information indicating a lane in which the emergency vehicle is traveling in an emergency, and
the third moving body is traveling in the lane.

3. The control method according to claim 1,
wherein the emergency information includes a travel speed and a current location of the emergency vehicle, and
the control method further comprises:
estimating, based on the emergency information, an estimated time at which the first moving body will be overtaken by the emergency vehicle, and stopping, before the estimated time, the first moving body on a shoulder of a road on which the first moving body is traveling.

4. The control method according to claim 1,
wherein the emergency information includes travel speed information and current location information of the emergency vehicle, and
the control method further comprises:
estimating, based on the travel speed information and the current location information, an estimated time at which the first moving body will be overtaken by the emergency vehicle, and moving the first moving body to a route different from the scheduled route before the estimated time.

5. The control method according to claim 1,
wherein the transmitting includes transmitting, when the third moving body is non-existent, the emergency information to a roadside device near the first moving body.

6. The control method according to claim 1, further comprising:
inquiring, when the emergency information is acquired, whether authority information indicating that the emergency vehicle is an authorized emergency vehicle is stored in a blockchain,
wherein the transmitting includes transmitting, when the authority information is stored in the blockchain, the emergency information to the third moving body or a roadside device near the first moving body.

7. The control method according to claim 5, further comprising:
moving the first moving body within a communication range of the roadside device when the first moving body cannot communicate with the third moving body or the roadside device in the transmitting.

8. The control method according to claim 5, further comprising:
providing a user a presentation prompting the user to move the first moving body within a communication range of the roadside device when the first moving body cannot communicate with the third moving body or the roadside device in the transmitting.

9. The control method according to claim 5,
wherein the roadside device includes a traffic light.

10. A moving body comprising:
an acquirer that acquires, from a first moving body, emergency information that includes information on a scheduled route on which an emergency vehicle travels in an emergency; and
a transmitter that transmits, by device-to-device communication, the emergency information to a second moving body that is predicted to travel on the scheduled route.

11. A non-transitory computer-readable recording medium having recorded thereon a program for causing a computer to execute the control method according to claim 1.
